(19) United States
(12) Patent Application Publication
(10) Pub. No.: US 2002/0113868 A1
(43) Pub. Date: Aug. 22, 2002

(54) Display apparatus of stereoscopic image via circular polarization

(75) Inventor: Tae Soo Park, Gyunggi-do (KR)

Correspondence Address: FLESHNER & KIM, LLP, P.O. Box 221200, Chantilly, VA, 20153-1200, US

(73) Assignee: LG Electronics Inc.

(21) Appl. No.: 10/058,331

(22) Filed: Jan. 30, 2002

(30) Foreign Application Priority Data
Feb. 21, 2001 (KR) 8728/2001

(51) Int. Cl. H04N 13/04

(52) U.S. Cl. 348/51

(57) ABSTRACT

The present invention relates to a display apparatus of the stereoscopic image via the circular polarization which comprises first and second image display devices arranged mutually perpendicular for displaying images respectively corresponding to left and right eyes; first and second polarizer plates respectively provided in the front of the first and second image display devices; a half-mirror provided between the first and second image display devices; and a glass window having a quarter-wave plate attached thereto for being opposed to the first image display device in parallel. The invention realizes a stereoscopic image in a circular polarization mode so as to reduce crosstalk due to the phase difference caused by observer's turning head and the difference of reflectivity and transmissivity of the half-mirror thereby improving appreciated image qualities.

### BACKGROUND OF THE INVENTION

1. Field of the Invention

The present invention relates to a solid image display industry for displaying solid images, and more particularly, to a display apparatus of solid image via circular polarization which can realize a stereoscopic image in a circular polarization mode by using a liquid crystal panel, vertical/horizontal polarizer plates, a half-mirror and a quarter-wave frequency plate to reduce crosstalk due to the phase difference caused by head revolution of an observer and the difference of reflectivity and transmissivity thereby improving appreciated image qualities.

2. Description of the Related Art

In recent days, apparatuses for displaying stereoscopic images are frequently required in order to obtain actual and dynamic images.

Generally in watching a stereoscopic image, an observer receives different images via left and right eyes and synthesizes the left and right images in the brain to feel solidity.

In order to provide the solid image, it is required an apparatus for displaying different images to the left and right eyes, for example, a display apparatus of stereoscopic image of the related art which divides right-eye and left-eye images to be separately detected in the left and right eyes via linear polarization.

FIG. 1 shows a display apparatus of solid image via linear polarization of the related art.

Referring to FIG. 1, the display apparatus 100 of stereoscopic image via linear polarization is comprised of the first liquid crystal panel 110, the second liquid crystal panel 120, a half-mirror 130 and a glass window 140.

The first liquid panel 110 and the second liquid crystal panel 120 are perpendicularly arranged in respect to each other, and the half-mirror 130 is installed between the first and second panels 110 and 120 for combining images.

The half-mirror 130 causes the first and second panels to be looked as if overlapped in the position of the first liquid crystal panel to the eyes of the observer.

FIG. 2 shows the structure of the liquid crystal panel in the conventional display apparatus of the stereoscopic image via the linear polarization.

Referring to FIG. 2, the first and second liquid crystal panels are so configured that linear polarizer plates 220 and 221 are attached to both sides of the liquid crystal 210 and an image displayed in the liquid crystal panel can be seen by a back light device 230.

In this case, the polarizing direction of an output light is inclined for 45° or −45° about a horizontal direction by the polarizer plate 220 attached to an output-side of the first or second liquid crystal panel (refer to (b) in FIG. 2)

FIG. 3 shows linear polarizing glasses used by an observer in a conventional display apparatus of the stereoscopic image via the linear polarization.

Referring to FIG. 3, the linear polarizing glasses used by the observer are inclined for ±45° in respect to a horizontal direction corresponding to the left and right eyes. Therefore, an output light from the first liquid crystal panel in FIG. 1 (considered to have a polarizing direction of 45°) is received in the eyes of the observer through the half-mirror 130.

In this case, since the polarizing direction of the image is maintained as it is, the polarizing direction of the output light is perpendicular to that of the left glass (where the polarizing direction is −45°) of the linear polarizing glasses and thus the light fails to pass the left glass, whereas the light passes only the right glass (where the polarizing direction is 45°) to enter the right eye.

Meanwhile, another output light from the second liquid crystal panel 120 (considered to have a polarizing direction of 45°) is directed to the eyes of the observer after being reflected from the half-mirror 130. In this case, the light is rotated 90° when reflected from the half-mirror 130 to have a polarization of −45°.

Therefore, the second output light fails to pass the right glass (where the polarizing direction is 45°) since the polarizing direction thereof is perpendicular to that of the right glass, whereas the second output light passes only the left glass (where the polarizing direction is −45°) to enter the left eye.

According to the related art like this, the images from the first and second liquid crystal panels are separately sensed in the left and right eyes via the linear polarization and synthesized in the brain so that the observer can feel solidity.

In a linear polarization technology like this, the right polarizing glass is required to completely shield the left image (image from the second liquid crystal panel) and the left polarizing glass completely shield the right image (image from the first liquid crystal panel). However, when the observer wearing the linear polarizing glasses leans the head, at least one of the left and right polarizing glasses fails to completely shield the image thereby creating a leakage of light as in Equation 1:

I′=I₀ SIN² θ_{g} Equation 1,

herein, I′ designates leakage of light, I0 designates the quantity of light incident to the glasses, and θ_{g} designates an angle of the glasses inclined from the horizon.

Further, if the light polarized from the first or second liquid crystal panel is inclined for 45°, the light can be divided into horizontal and vertical components in respect to the incident surface of the half-mirror, in which the horizontal and vertical components have features different from each other in passing through or being reflected from the half-mirror.

In other words, the horizontal and vertical components are different in the phase shift according to coating conditions of the half-mirror as well as in reflectivity and transmittance thereof.

Therefore, the phase differences of the horizontal and vertical components are necessarily 0 or 180° in the foregoing linearly polarized light with the same amplitude and phase as a condition of linear polarization. However, when the light with polarizing direction inclined for 45° transmits or is reflected from the half-mirror, the phase shift or amplitude is varied according to coating conditions of the half-mirror to cause the elliptic polarization generating leakage of light, which are reasons of crosstalk in the left and right images.

Further, crosstalk may take place when the observer turns the head.

There are disadvantages that crosstalk in the left and right images incurred like this degrade the stereoscopic image while incurring medical problems such sore eyes, dizziness, headache and the like.

### SUMMARY OF THE INVENTION

A display apparatus of stereoscopic image via circular polarization comprises first and second image display devices arranged mutually perpendicular for displaying images respectively corresponding to left and right eyes; first and second polarizer plates respectively provided in the front of the first and second image display devices; a half-mirror provided between the first and second image display devices; and a glass window having a quarter-wave plate attached thereto for being opposed to the first image display device in parallel.

In the display apparatus of the stereoscopic image via the circular polarization, the first polarizer plate has a vertically or horizontally directed polarizing axis, and the second polarizer plate has a horizontally or vertically directed polarizing axis.

### BRIEF DESCRIPTION OF THE DRAWINGS

FIG. 1 shows a display apparatus of stereoscopic image via linear polarization of the related art.;

FIGS. 2A and 2B show the structure of a liquid crystal panel in a display apparatus of stereoscopic image via linear polarization of the related art;

FIG. 3 shows linear polarizing glasses used by an observer in a display apparatus of stereoscopic image via linear polarization of the related art;

FIG. 4 shows a display apparatus of stereoscopic image via circular polarization of the invention;

FIGS. 5A and 5B show an optical axis of a quarter-wave plate in a display apparatus of stereoscopic image via circular polarization of the invention; and

FIG. 6 shows polarizing directions in circular polarizing glasses in use for a display apparatus of stereoscopic image via circular polarization of the invention.

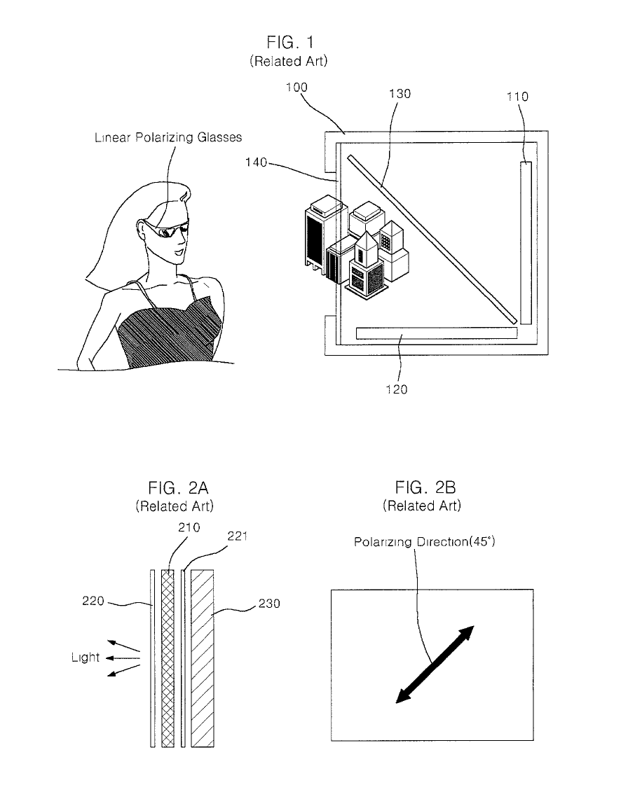

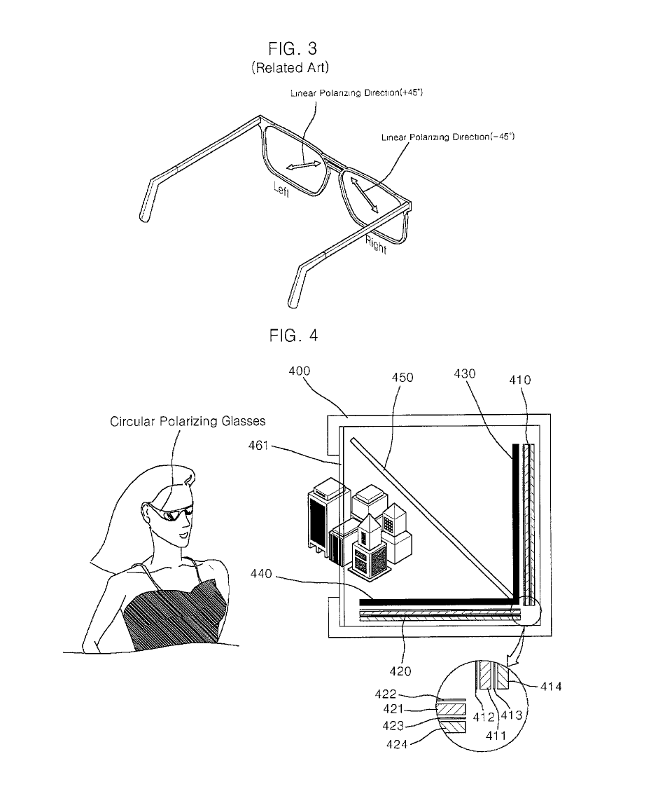

### DETAILED DESCRIPTION OF THE PREFERRED EMBODIMENT

Hereinafter detailed invention will be made about an embodiment of the invention in reference to the accompanying drawings.

FIG. 4 shows a display apparatus of stereoscopic image via circular polarization of the invention.

Referring to FIG. 4, a display apparatus 400 of stereoscopic image via circular polarization is comprised of the first liquid crystal panel 410 having a liquid crystal 411, linear polarizer plates 412 and 413 attached to both sides of the liquid crystal 411 and a back light device arranged in the rear of the linear polarizer plate 413 as the rear one of the linear polarizer plates 412 and 413; the second liquid crystal panel 420 arranged perpendicular to the first liquid crystal panel 410 and having a liquid crystal 421, linear polarizer plates 422 and 423 attached to both sides of the liquid crystal 421 and a back light device arranged in the rear of the linear polarizer plate 423 as the rear one of the linear polarizer plates 422 and 423; the first and second polarizer plates 430 and 440 respectively arranged in the front of the first and second liquid crystal panels 410 and 420; a half-mirror 450 arranged between the first and second liquid crystal panels 410 and 420 at an inclination of 45°; and a glass window 460 having a quarter-wave plate 461 attached thereto as opposed in parallel to the first liquid crystal panel.

The first and second liquid crystal panels 410 and 420 are arranged perpendicular from each other, and the half-mirror 450 is arranged therebetween for combining images from the panels 410 and 420. Therefore, the half-mirror causes the first and second panels to be looked as if overlapped in the position of the first liquid crystal panel to the eyes of the observer.

On the top surface of the first and second liquid panels are attached with the polarizer panels which have vertical (or horizontal) and horizontal (or vertical) polarizing axial directions.

Meanwhile, the quarter-wave plate 461 is arranged in the glass window 460 to which the images come out from the first and second panels at the same time.

An observer wears the circular polarizing glasses so that left and right eyes respectively sense the images of the first and second panels separated from each other.

Each of the first and second panels is configured such that the linear polarizer plates are attached to the both sides of the liquid crystal and the image displayed in the liquid crystal panel can be watched via the back light device similar to the related art. In this case, the polarizing direction of an output light is inclined for 45° (or −45°) in respect to horizontal directions of the polarizer plates attached to an output-side of the first and second panels.

In this case, as mentioned in the related art, when the light transmits or is reflected from the half-mirror as inclined for 45° (or −45°), elliptic polarization takes place to incur the crosstalk. Therefore, on the first liquid crystal panel 410 is installed with the first polarizer plate 430 with the vertical polarizing in the axial direction, and on the second liquid crystal panel 420 is installed with the second polarizer plate 440 with the horizontal polarizing in the axial direction.

The first and second polarizer plates respectively permit a horizontally or vertically directed polarization component to transmit or be reflected from the half-mirror 450 so that the polarizing directions are maintained without elliptic polarization. Further, the quarter-wave 416 is attached to the surface of the glass window 460 to which all of the images come out from the first and second liquid crystal panels.

FIG. 5 shows an optical axial direction of a quarter-wave plate in the display apparatus of the stereoscopic image via circular polarization of the invention.

Referring to FIG. 5, (a) of FIG. 5 shows lights radiating from a quarter-wave plate 520 attached to a glass window 510, and the optical axis (axis with the fastest propagating speed of the lights) of the quarter-wave plate is inclined for 45° in respect to horizon as in (b) of FIG. 5.

Therefore, the image of the first liquid crystal panel 410 of FIG. 4 has the polarizing direction which is vertically directed by the first polarizer plate 430 so as to be inclined in respect to the optical axis of the quarter-wave plate. Thus, the vertically directed image light, which transmitted the first polarizer plate 430, can be divided into two mutually crossing linear polarization components with the same magnitude of amplitude and phase, in which the two mutually crossing linear polarization components have a phase difference of π/2 when coming out of the quarter-waver plate 461 thereby forming a left circularly polarized light due to this phase difference.

Further, the image of the second liquid crystal panel 420 has the polarizing direction which is horizontally directed by the second polarizer plate 440 so as to be inclined for −45° in respect to the optical axis of the quarter-wave plate. Therefore, the horizontally directed image light, which transmitted the second polarizer plate 440, can be divided into two mutually crossing linear polarization components with the same magnitude of amplitude and phase, in which the two mutually crossing linear polarization components have a phase difference of π/2 when coming out of the quarter-waver plate 461 and thus form a right circularly polarized light.

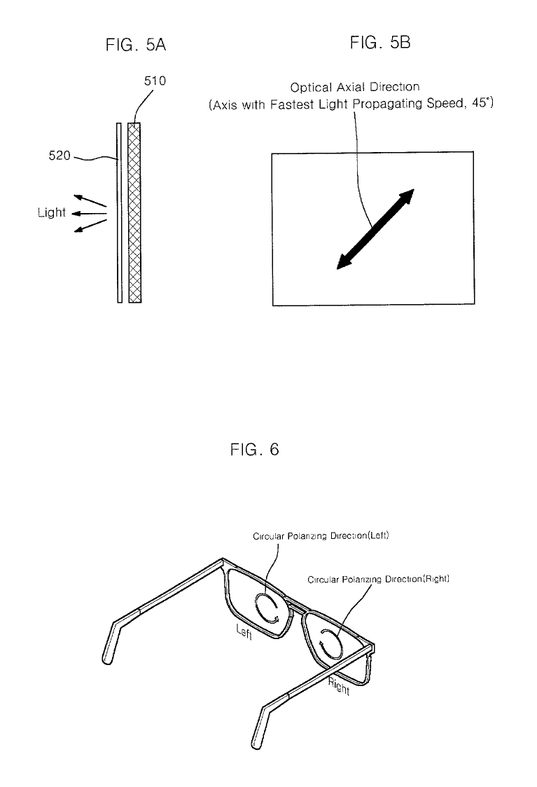

FIG. 6 shows polarizing directions in circular polarizing glasses in use for the display apparatus of the stereoscopic image via the circular polarization of the invention.

Therefore, the observer can respectively sense the separated images in the first and second panels in the left and right eyes and synthesize the images in the brain to sense solidity when wearing the circular polarizing glasses as shown in FIG. 6.

Due to such circular polarization, the images in the first and second panels are separated and transmitted to the both eyes even when the observer inclines the head.

According to the invention as described hereinbefore, the liquid panels, the vertical/horizontal polarizer plates, the display apparatus of stereoscopic image via circular polarization can realize the stereoscopic image in a circular polarization mode by employing the liquid crystal panel, the vertical/horizontal polarizer plates, the half-mirror and the quarter-wave frequency plate to reduce crosstalk due to the phase difference caused by observer's turning head and the difference of reflectivity and transmissivity of the half-mirror thereby improving appreciated image qualities.

What is claimed is:

1. A display apparatus of stereoscopic image using circular polarization, comprising:
first and second image display devices arranged in perpendicular from each other for displaying images corresponding to both left and right eyes;
first and second polarizer plates respectively provided in the front of said first and second image display devices;
a half-mirror provided between said first and second image display devices; and
a glass window having a quarter-wave plate in order to opposed said first image display device in parallel.

2. The display apparatus according to claim 1, wherein said first polarizer plate has a vertically or horizontally directed polarizing axis, and said second polarizer plate has a horizontally or vertically directed polarizing axis.

3. The display apparatus according to claim 1, wherein said half-mirror has a slope of 45° about both of said first and second image display devices.

4. The display apparatus according to claim 1, wherein each of said first and second image display devices is made of a liquid crystal panel.

5. The display apparatus according to claim 4, wherein said liquid crystal panel has linear polarizer plates attached to both front and rear sides of a liquid crystal, and a back light arranged in the rear side arranged in the middle and rear of said linear polarizer plates.
